(19) United States
(12) Patent Application Publication
(10) Pub. No.: US 2009/0248449 A1
(43) Pub. Date: Oct. 1, 2009

(54) Care Plan Oversight Billing System

(75) Inventor: Gursharan Dhillon, Rochester Hills, MI (US)

Correspondence Address: YOUNG BASILE, 3001 WEST BIG BEAVER ROAD, SUITE 624, TROY, MI, 48084, US

(73) Assignee: Stat Physician P.C., Rochester Hills, MI (US)

(21) Appl. No.: 12/414,222

(22) Filed: Mar. 30, 2009

Related U.S. Application Data
(60) Provisional application No. 61/040,412, filed on Mar. 28, 2008.

(51) Int. Cl. G06Q 30/00; G06F 17/30; G06F 17/40; G06F 3/048; G06Q 50/00

(52) U.S. Cl. 705/3; 707/10; 707/3; 715/760; 715/856; 715/780; 705/34; 707/E17.044; 707/E17.014

(57) ABSTRACT

A system for billing Care Plan Oversight services including storing patient data in a databases; accumulating time for Care Plan Oversight services provided to individual patients in the patient databases; and periodically calculating a total accumulated time for Care Plan Oversight services provided to each patient in a predetermined time period window and if greater than a predetermined threshold, generating a billing statement for that particular patient.

### RELATED APPLICATIONS

This application claims the benefit under 35 U.S.C. §119(e) of U.S. Provisional Application Ser. No. 61/040,412 filed Mar. 28, 2008, which is incorporated by reference herein in its entirety.

### FIELD OF THE INVENTION

The present invention relates to a web based billing system for Medicare services provided through Care Plan Oversight.

### BACKGROUND OF THE INVENTION

Family physicians spend a lot of time on the phone following up with patients, family and other caregivers to coordinate the care of patients. Unfortunately, most insurance companies' do not reimburse physicians for the amount of time spent in the phone, and physicians are specifically prohibited from billing Medicare patients for phone calls. Medicare considers this pre-visit and post-visit work to be a bundled component of Evaluation and Management (E/M) services. However, there is non-face-to-face service but can be billed for and will be reimbursed by Medicare: namely, Care Plan Oversight (CPO). Physicians often provide the service but do not bill for it because the rules are both complicated and extremely specific. The rules specify which provider can bill the service, which beneficiaries are eligible to receive the service, and which components make up Care Plan Oversight. However, the reimbursement for the service justifies taking some time to learn the rules, document the time spent and bill for the service. Apparently, growing numbers of physicians have been sorting through Care Plan Oversight CPO complexities. The Centers for Medical and Medicaid Services (CMS) have noted a significant increase in the payment to physicians for (CPO), from $15 million in 2000 to $41 million in 2001. As a result billing for CPO is an area that the Department of Health and Human Services Office of the Inspector General (OIG) has announced it will be scrutinizing more carefully this year for evidence of fraud.

### SUMMARY OF THE INVENTION

On-line, web-based, software keeps patient information safe on a secure server. The physician and the office staff have log in ID's with unique password protection. Whenever the physician gets a phone call from the hospice or the homecare agency, and if he or she thinks that it is billable time, the physician can log in and enter the minutes himself or herself. Also when the paperwork is received from these agencies, the physician can write on the paperwork how much time was spent and the staff can enter the minutes spent into the software. At the end of the work, or at the end of the month, the software will calculate which patients are eligible to be billed along with the appropriate diagnosis. The agency name can be displayed on the billing report, and staff does not have to go back and forth to look in each patient's chart. The software saves time for the physician and staff in entering, calculating and billing the time spent i dealing with paper work received from homebound patients. The software is an excellent tool as the data can be entered from any computer. Data is safely stored and available to be viewed anytime. This software helps physicians reduce paperwork and get paid for the time they actually spent taking care of patients. The software will also create an online invoice for the physician's office for a small percentage of the amount billed.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a simplified flow chart illustrating the online web-based software flow;

FIG. 2 is a screen shot of the sign in screen requesting user name and password;

FIG. 3 is the welcome screen after successfully logging in;

FIG. 4 is a screen shot of a patient list with data removed for confidentiality;

FIG. 5 is a screen shot of blank data fields to be filled in to create a new patient profile;

FIG. 6 is a screen shot of a pop-up for data entry into a particular patient file;

FIG. 7 is a screen shot of a billing screen with data removed for confidentiality; and

FIG. 8 is a screen shot showing billing history with data removed for confidentiality.

### DETAILED DESCRIPTION

If a physician's situation meets all the requirements listed below, the physician is eligible to bill for services: (1) the physician cannot have a significant financial arrangement with the home health agency or hospice that is providing care to the patient; (2) the physician may not be an employee or medical director of the home health care agency or hospice; (3) only one physician per month may bill CPO; (4) neither a physician who is billing for end-stage renal disease services under a capitation arrangement nor a physician who is providing surgical follow-up in the global period may bill for CPO; (5) the physician who bills for the CPO must be the same physician who signed the certification for the home health agency or hospice in the first place; (6) the physician must have had a face-to-face service with the patient within 6 months of billing for the CPO; (7) the physician must have personally provided at least 30 minutes of service in one calendar month; (8) the beneficiary must be receiving Medicare covered home health or hospice services during the period in which CPO is billed; and (9) the beneficiary must require complex or multidisciplinary care modalities requiring ongoing physician involvement in the patient's plan of care.

The CPT manual defines CPO using six CPT codes, 99374 through 99380. Specifically, 99374 is used for 15 to 29 minutes and 99375 for 30 minutes or more. For services relating to hospice care, 99377 is used for 15 to 29 minutes and 99378 is used for 30 minutes or more. For services relating to nursing facility care, 99379 is used for 15 to 29 minutes and 99380 is used for 30 minutes or more. The physician must check with the various health plans to find out whether the health plan pays for these services; many do not pay for these services. Medicare however uses two HCPCS codes, G0181 and G0182, to define and pay for CPO. The definition of G0181 is “physician supervision of a patient receiving Medicare-coverage services provided by a participating home health agency (patient not present) requiring complex and multi disciplinary care modalities involving regular physician development and/or revision of care plans, review of subsequent reports of patent status, review of laboratory and other studies, communication (including telephone calls with other health care professionals involved in the patient's care, integration of that information into the medical treatment plan and/or adjustment of medical therapy within a calendar month, 30 minutes or more). G0182 describes the same service for a patient in a Medicare-approved hospice. HCPCS code G0181 has 3.28 relative value (RVU's) and G0182 has 3.46 (RVU's). By comparison, a patient visit coded as 99213 has 1.39 (RVU's). These are the national non-geographically adjusted RVU values.

A physician or non-physician practitioner must personally furnish CPO services. CMS recently clarified that a non-physician practitioner may bill for CPO. CMS defines non-physician practitioner as a nurse practitioner, a clinical nurse specialist or a physician assistant, and requires that the non physician practitioner have a collaborative relationship with the physician who signed the initial hospice or home health agency plan of care. The CPO services must take at least 30 minutes in a calendar month to be billable. The services do not need to be provided on the same day, but the total services over the course of a month must add up to at least 30 minutes. The physician or non-physician practitioner must personally document the date, the time spent and a brief description of the activities provided in the patient's record. The services should be billed to Medicare with a start date of the first of the month and an end date of the month's final day.

The following list helps sort out the activity a physician or non-physician practitioner can or cannot count toward the Care Plan Oversight time to be billed. A physician or non-physician practitioner can bill for the time spent: (1) reviewing charts, reports and treatment plans; (2) reviewing diagnostic studies if the review is not part an E/M service; (3) talking on the phone with other health care professionals who are not employees of the practice and are involved in the patient's care; (4) conducting team conferences; (5) discussing drug treatment and interactions (not routine prescription renewals) with a pharmacist; (6) coordinating care if physician or non-physician practitioner time is required; and (7) making and implementing changes to the treatment plan. A physician or non-physician practitioner cannot bill for the time spent: (1) renewing prescriptions; (2) talking with fellow employees at the practice; (3) traveling; (4) preparing or submitting claims; (5) talking to the patient's family, even if discussing treatment plan changes; (6) holding informal consults with physician's who are not treating the patient; (7) working on discharge services (99217 for observation care discharge, 99238 or 99239 for hospital discharge); and (8) interpreting test results at an E/M visit. In addition, a physician or non-physician practitioner may not bill for Care Plan Oversight work performed by staff who are neither physicians nor non-physician practitioners (defined by Medicare as a nurse practitioner, a clinical nurse specialist, or a physician assistant who has a collaborative relationship with a physician who signed the initial hospice or home health agency plan of care).

Patients are eligible to receive CPO services if they require complex treatment, are being cared for by multi disciplinary teams, and are under the care of a Medicare-approved home health agency or hospice. For example, a family physician sees an elderly patient with diabetes who lives alone and has non-healing skin ulcers. The patient is enrolled in and receiving services from a home health agency, and the physician signs the initial plan of care. Over the course of the month, the physician coordinates care with the agency's nursing staff, arranges for treatment at a wound clinic and talks to the treating physician there, reviews multiple lab results not related to an office visit or other E/M service and adjust the patient's medication. The physician spends more time than 30 minutes during the month doing these activities, documents the dates, times and services, and bills G0181.

Another example is medical care for a patient undergoing chemotherapy for colon cancer. The family physician signs the plan of care, certifying the patient for home health services, and provides an E/M service. During the course of the month, the physician discusses the patient's care with the oncologist, manages the patient's pain, arranges for nutrition services and interacts with the home health agency staff. Over the course of the calendar month, the physician spends more than 30 minutes on these activities and documents the services, dates, and time, then G0181 can be billed.

Billing for Care Plan Oversight requires the establishment of a monthly routine to ensure payment for services. One manual approach would be to first create a written log of all patients for whom CPO is provided each month. The log list can remind the physician or non-physician practitioner which charts to pull at the end of the month when it is time to submit claims for payment of services provided during that month. Second, a written CPO service log can be kept in each patient's chart and the physician can document the date, total time and a brief description of the services, each time services are provided to that particular patient. The CPO documentation must be signed by the physician or non-physician practitioner. At the end of the month, a staff person can collect the logs from the patient's charts, total the time and bill CPO for those patients that have been provided more than 30 minutes of CPO during the calendar month. Use the start and end dates of the month as the service dates, and put the provider number of the home health agency/hospice on the claim form. Finally, return the logs to the charts for use in future months.

The challenges for billing for Care Plan Oversight is that there are several thousand charts in a typical primary care practice and most of those charts are stored in a paper format. Most practices that have charts alphabetically lined up in the chart cabinet. When a HCFA 485 form is received from the home care or hospice agency the form is signed and filed in the patient's chart. Subsequent forms from these agencies are also signed and filed. It is difficult to keep tab of minutes spent with the agency staff and insert those minutes in each chart each day. Finally, it is impossible to pull out each patient chart at an end of the month and see if any patient has 30 minutes or more of care provided. Also time spent by the physician office is scattered between the physician, medical assistants, nurse and receptionist. Mostly the physician is the final decision maker to change plan of care. There are several agencies, which send the paperwork to the physician's office, and each agency has their unique way of sending information. Not all the agencies send paperwork in timely fashion. There is not one contact person who enters information in a patient's chart and gets the charts, which have met the requirements to be billed.

The Care Plan Oversight billing software was created by a physician after trying several years of paper method of collecting data and entering minutes and finally analyzing which patient can be billed. The on-line web based billing software solution solves the difficulties encountered by physicians in dealing with the collection of data, entering minutes, and analyzing which patient's can be billed. The software could also be provided in a standalone or network version, rather than the online web-based version, if desired. The online software keeps the patient information safe on a secure server. The physician and the office staff have log in ID's which are unique password protected. Whenever the physician gets a phone call from the hospice or home care agency, and if he/she thinks it is billable time, the physician can log in and enter the minutes himself or herself. Also, when the paper work is received from these agencies, the physician can write on the paperwork how much time was spent and the staff can enter the minutes spent into the CPO billing software. At the end of the week or the end of the month, the software will calculate which patients are eligible to be billed along with the appropriate diagnosis. Also, the agency name can be displayed on the billing report, and staff does not have to go back and forth to locate each patient's chart. The CPO billing software saves time for the physician and his staff in entering, calculation, and billing the time which was spent on dealing with the paperwork for homebound patients. The CPO billing software is an excellent tool. The online version allows data to be entered from any computer. Data is safely stored and available to be viewed at any time. The CPO billing software helps a physician reduce paperwork and get paid for the time which is actually spent taking care of patients. The CPO billing software can also create an online invoice for the physician office. The online version can be marketed to provide billing services in return for a small percentage of the amount billed.

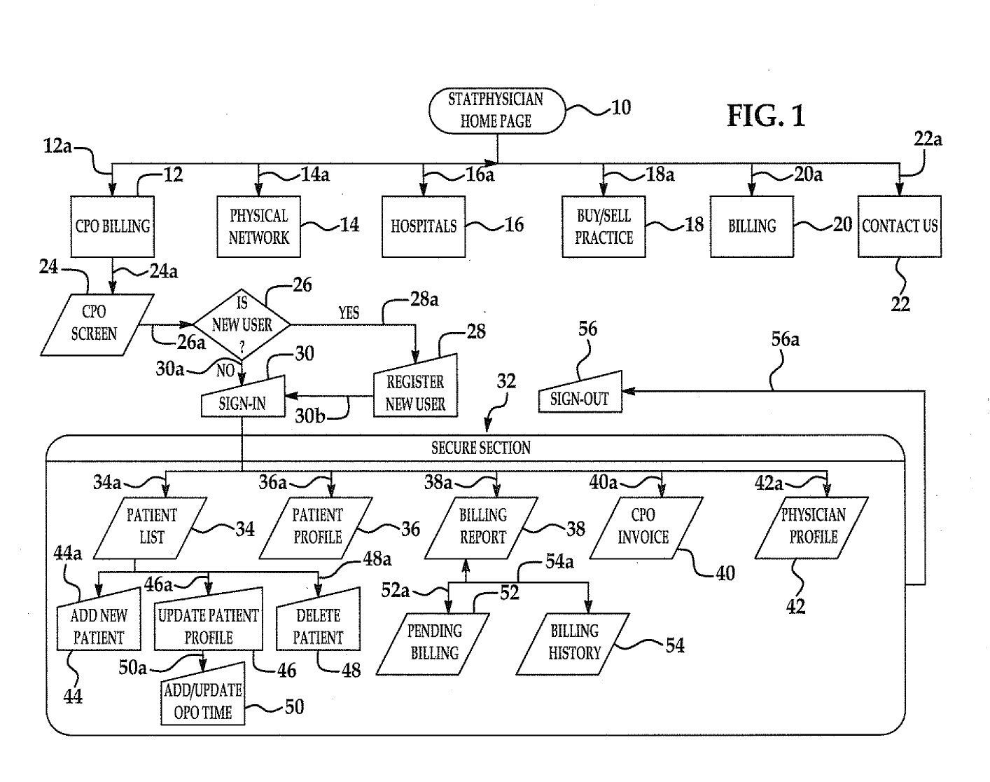

Referring now to FIG. 1, a flowchart illustrates the flow through various pages of the online web based CPO billing software. The standalone or network versions of the software would be similar to that illustrated in FIG. 1. The online user is first presented with a home page 10. The home page 10 provides the opportunity to jump to one of the following page options: CPO billing page 12 through link 12a, Physician Network page 14 through link 14a, Hospitals page 16 through link 16a, Buy/Sell Practice page 18 through link 18a, Billing page 20 through link 20a, and Contact Us page 22 through link 22a. If the CPO billing page 12 is selected through link 12a, the CPO screen 24 is displayed. On the CPO screen 24, it is determined if the sign-in is for a new user 26. If the sign-in is for new user, the software branches to registration of the new user 28. If the sign-in is not by a new user or if a new user has been registered, the software continues to the sign in screen 30 of the online user. Once the online user has signed in on the sign-in page 30, the software allows access to the secure section 32. In the secure section 32, the online user is provided access to select one of the following: (1) patent list page 34 through link 34a; (2) patient profile page 36 through link 36a; (3) billing report page 38 through link 38a; (4) CPO invoice page 40 through link 40a; and (5) physician profile page 42 through link 42a. If the patient list screen 34 is selected through link 34a, the online user can then select one of the following: (1) add new patient screen 44 through link 44a; (2) update patient profile screen 46 through link 46a; or (3) delete patient screen 48 through link 48a. If the update patient profile screen 46 is selected through link 46a, the add/update CPO time screen 50 for that particular patient is displayed for online user data entry. When in the secure section 32, if the report screen 38 is selected, the online user can then select the pending billing 52 screen or the billing history 54 screen. When the online user wishes to leave the secure section 32, the online user selects the sign out and is presented with the sign out page 56 which ends the online user's access to the secure section 32.

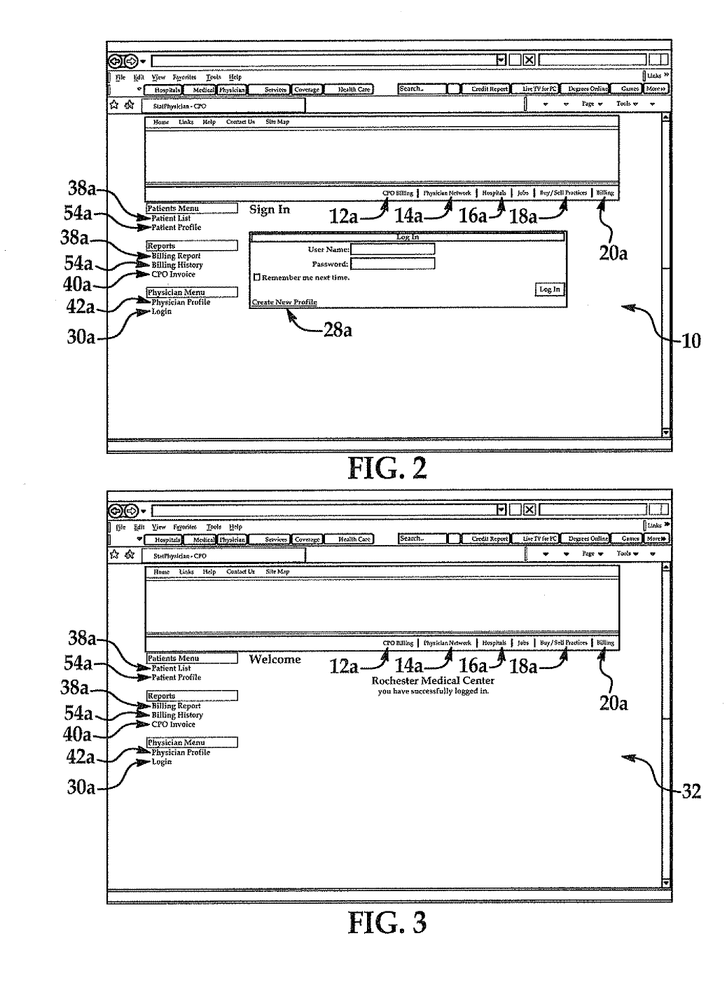

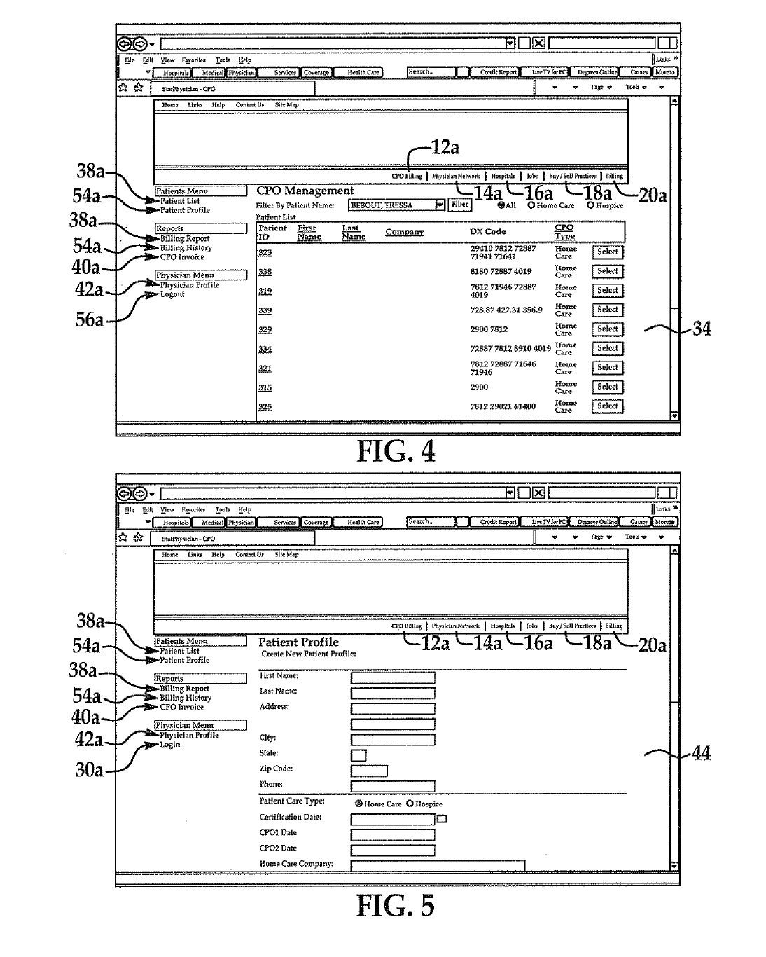

Referring now to FIG. 2, the sign-in screen 30 is illustrated with a link 28a to create a new user profile 28 and with links 12a, 14a, 16a, 18, 20a, 22a to the main headings for CPO billing screen 12, physician network screen 14, hospital screen 16, buy/sell practice screen 18, billing screen 20, and contact us screen 22, respectively.

After an online user has successfully logged in, FIG. 3 welcome screen to the secure section 32 appears. From this screen as illustrated in FIG. 3, the user can access the links 34a, 36a, 38a, 40a, 42a to the patient list screen 34, patient profile screen 36, billing report screen 38, CPO invoice screen 40, and physician profile screen 42, respectively. Each physician has a unique user log-in ID and password to securely log into the CPO billing software from any computer or cell phone which has internet access through the first sign-in screen page 30. Once the physician logs in, the secure section screen 32 illustrated in FIG. 3 welcomes the logged in online physician user by showing the appropriate practice name. The data stored in the CPO billing software is stored on a secure server and is HIPPA compliant.

If the patient list screen 34 is selected, the screen can display an entire list of patients which have been entered, and can also display the home care/hospice company's name along with patient's diagnosis. The patient list can be filtered by patient name, if desired. The list can also be filtered by showing all patients, or limiting the list to home care patients, or limiting the list to hospice patients. Each patient is assigned a unique ID or can be searched using the filter. Patient's data can also be retrieved using the home care or hospice filter criteria. If the add new patient screen 44 is selected, a new patient profile data entry screen is displayed as illustrated in FIG. 5. The appropriate data is entered and the add new patient screen 44 by the online user and once updated, the new patient profile will show on the patient list screen 34.

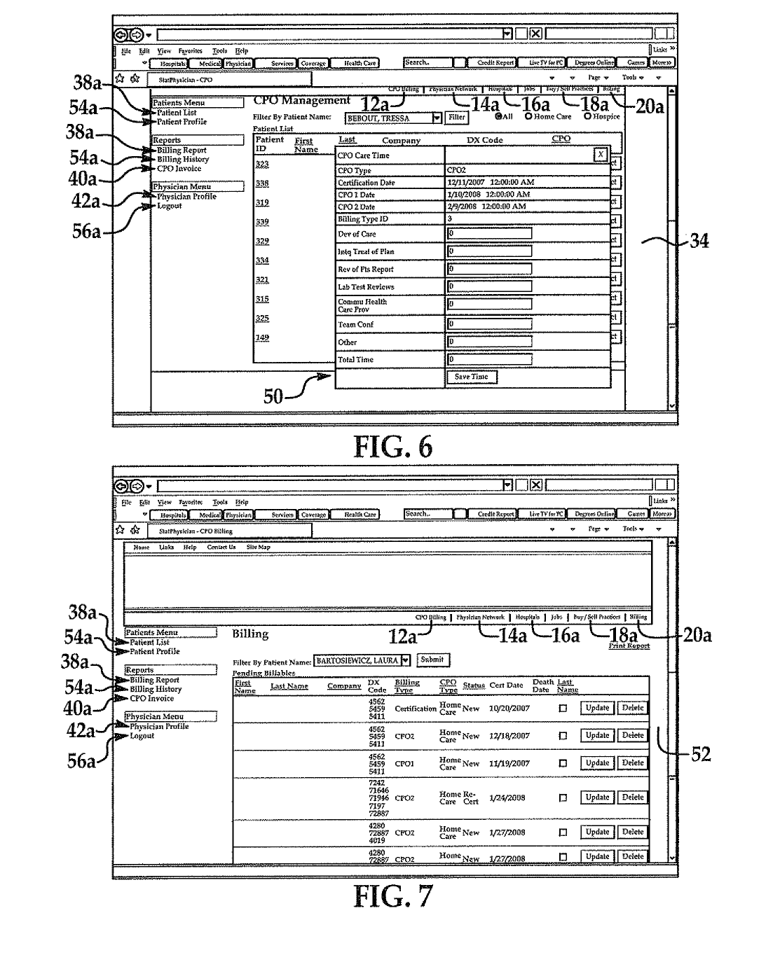

If the update patient profile 46 screen is selected from the patient list screen 34 by selecting an individual patient, the add/update CPO time screen 50 will display as illustrated in FIG. 6. When the patient is selected, it automatically brings the subsequent CPO 1 and CPO 2 data up in an overlay on the patient list screen 34. The add/update CPO time screen 50 displays the subsequent two CPO data periods (CPO 1 and CPO 2) for home care patients, and if it is a hospice patient six CPO data periods are displayed. Minutes can be added in any row as considered appropriate by the physician or non-physician practitioner. The CPO billing software will automatically save time and when the displayed screen adds up to 30 minutes or more for a particular month, the CPO billing software will generate a billing report for that patient.

If the billing report screen 38 is selected, the list of pending billables is displayed by patient name. The list can be filtered by patient name. The billing report contains all the patients which are ready to be billed for Care Plan Oversight. The biller can put a check mark in the column after billing and then the patient's name is sent to the billing history report. A physician using an out of office biller can print the report and send it to the biller for billing. The pending billing screen 52 is illustrated in FIG. 7. The online biller can put a check mark in a column after billing and then the patient name is sent to billing history report screen 54.

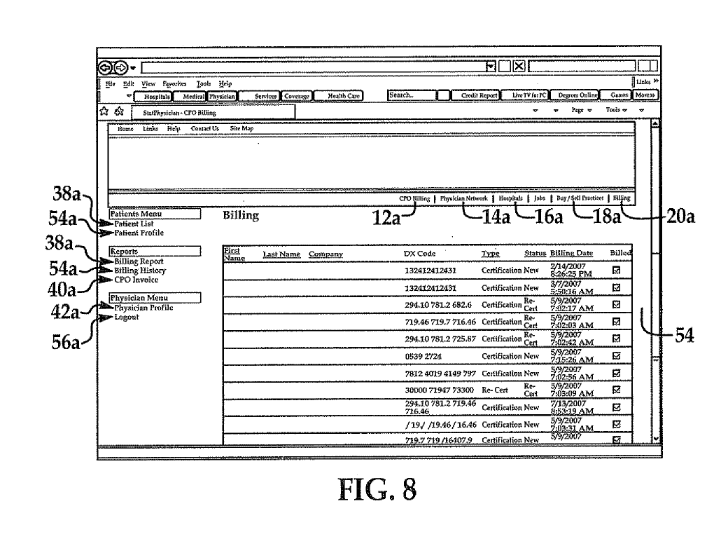

Referring now to FIG. 8, the billing history screen 54 keeps a running data list of patients which have been billed, for which kind of CPO and on which date. The billing history also stores which company had offered services to the patient. It makes it easier to contact the company to get data in case of an audit. The billing history also saves the diagnosis codes and displays the diagnosis codes on the screen. The Care Plan Oversight invoice screen will save the data for how many CPO's are billed each month and contains a copy of the invoice.

The Care Plan Oversight billing software provides an easy use online, web-based system allowing a physician or a non-physician practitioner to keep accurate records regarding Home Plan Oversight services provided to patients. The CPO billing software collects individual patient data, diagnosis, certification, and service provider information. For each patient, the CPO billing software then collects data regarding the amount of time spent by the physician or non-physician practitioner providing billable services to the patient. The physician or non-physician practitioner enters the appropriate amount of time spent on billable services in each patient's data base on an ongoing basis. At the end of each calendar month, the CPO billing software accumulates and calculates the amount of billable time spent by the physician or non-physician practitioner for each particular patient and determines if it meets a threshold of 30 minutes or more for billing purposes for that month. For each patient who has been rendered billable services greater than the minimum threshold, the appropriate data is sent to the pending billing screen list for billing. After billing, a billing history list is generated and maintained for future reference.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law

What is claimed is:

1. A system for billing care plan oversight services comprising:
storing patient data in a database;
accumulating time for care plan oversight services provided to individual patients in the patient database;
periodically calculating a total accumulated time for care plan oversight services provided to each patient in a predetermined time period window; and
if the total accumulated time provided to a particular patient in a predetermined time period window is greater than a predetermined threshold, generating a billing statement for that particular patient.

2. The system of claim 1 further comprising:
allowing user access and data input through a internet web based billing care plan oversight program.

3. The system of claim 1 further comprising:
collecting from each patient data including individual patient data, diagnosis, certification, and service provider information.

4. The system of claim 1 further comprising:
providing remote internet based access to a patient list screen, a patient profile screen, a billing report screen, a CPO invoice screen, and a physician profile screen.

5. The system of claim 4 further comprising:
if the patient list screen is selected, the screen displays an entire list of patients which have been entered, and displays the home care/hospice company's name along with patient's diagnosis.

6. The system of claim 5 further comprising:
if the patient list screen is selected, filtering the patient list by patient name.

7. The system of claim 5 further comprising:
if the patient list screen is selected, filtering the patient list by limiting the list to one of home care patients, and hospice patients.

8. The system of claim 5 further comprising:
if the patient list screen is selected, assigning each patient a unique identification number.

9. The system of claim 5 further comprising:
if the patient list screen is selected, retrieving data with a home care or hospice filter criteria.

10. The system of claim 5 further comprising:
if the patient list screen is selected, and if add new patient is selected, displaying a new patient profile data entry screen.

11. The system of claim 4 further comprising:
if the patient profile screen is selected, and if an individual patient is selected, displaying an add/update CPO time screen; and
automatically displaying data for the selected patient where the display includes two CPO data periods (CPO 1 and CPO 2) for home care patients, and six CPO data periods for a hospice patient.

12. The system of claim 11 further comprising:
if the patient profile screen is selected, and if an individual patient is selected, updating minutes in any row of the screen as considered appropriate by user.

13. The system of claim 4 further comprising:
if the billing report screen is selected, displaying a list of pending billables by patient name.

14. The system of claim 13 further comprising:
if the billing report screen is selected, filtering the list by patient name.

15. The system of claim 13 further comprising:
if the billing report screen is selected, displaying all patients which are ready to be billed for Care Plan Oversight; and
after billing allowing a biller to place a check mark in the column after billing to send the billed data to a billing history report.

16. The system of claim 13 further comprising:
if the billing report screen is selected, printing a billing report for a physician using an out of office biller; and
sending the report to the out of office biller for billing.

17. The system of claim 13 further comprising:
if the billing report screen is selected, allowing an online biller to place a check mark in a column after billing; and
sending the billing data to a billing history report screen.

18. The system of claim 4 further comprising:
if the billing history screen is selected, displaying a running data list of patients which have been billed, for which kind of CPO and on which date.

19. The system of claim 18 further comprising:
storing data identifying which company had offered services to the patient, and diagnosis codes.

20. The system of claim 4 further comprising:
if the CPO invoice screen is selected, displaying how many CPO's are billed each month, and a copy of a corresponding invoice.
